(19) United States
(12) Patent Application Publication
(10) Pub. No.: US 2003/0043587 A1
(43) Pub. Date: Mar. 6, 2003

(54) Decorating lamp unit

(75) Inventor: Simon L. Elster, Montreal (CA)

Correspondence Address: COLLARD & ROE, P.C., 1077 Northern Boulevard, Roslyn, NY, 11576-1696, US

(73) Assignee: ILLUMINATION S.L.E. INC.

(21) Appl. No.: 10/229,434

(22) Filed: Aug. 28, 2002

(30) Foreign Application Priority Data
Aug. 29, 2001 (CA) 2,356,014

(51) Int. Cl. F21V 21/00

(52) U.S. Cl. 362/388; 362/269; 362/319; 362/432

(57) ABSTRACT

A decorating lamp unit which can be assembled as a desk or table lamp or as a wall lamp in a simple and convenient manner. The present invention discloses a decorative lamp comprising a support frame, a first shade and a light bulb assembly. More particularly, the present invention discloses a decorating lamp unit that is wall mountable by fixing the support frame to a wall, or the lamp may be free-standing when placed on a surface with three contact points contacting said surface.

### FIELD OF THE INVENTION

The present invention relates to a decorating lamp unit. More particularly, the present invention relates to a decorating lamp unit which can be assembled as a desk or table lamp or as a wall lamp in a simple and convenient manner.

### BACKGROUND OF THE INVENTION

Lighting units are used for a variety of applications, for example, illuminating, designating and signalling areas, wherein the lamp unit is attached or mounted onto a structure and/or object of different size and shape. Generally, lighting units can be classified as wall mounted, free standing, or a combination of both. In such latter case, the lamp is considered to be an interchangeable wall or table lamp. In this connection, there exist several prior art documents describing lamp units. More particularly, the prior art documentation describe various types of shading and supporting means that enable the ready conversion of a table lamp to a wall lamp and vice-versa that may be used herewith.

U.S. Pat. No. 217,947 (Johnston) discloses a lamp having an oil-fount arranged on a pedestal or arm connected to a suitable base. The pedestal and fount are provided with a means for locking the lamp in different positions, whereby it may be used as a stand or pedestal lamp, with the burner always held in a vertical position.

U.S. Pat. No. 2,449,250 (Richter) discloses a cooperating lamp and wall bracket whereby the lamp may be supported by the bracket and is characterized by a means for releasably locking the lamp from the bracket. Such a mechanism can be used to prevent accidental or intentional removal of the lamp from the bracket.

U.S. Pat. No. 2,516,866 (Halpern) discloses an electrical illuminating lamp that rests on and adorns tables, beds and other furniture. More particularly, the invention relates to a lamp, which can be quickly and easily converted into a standing lamp or a hanging lamp by making use of movable supporting members. Such supporting members are constructed and arranged in such a way that in one position they provide a stand or base for the shade and in another position they provide a hanger for the shade.

U.S. Pat. No. 4,268,896 (Mann) discloses a lampshade concept, wherein the lamp has a supporting structure to which shading components, flat sheets of flexible sheeting, may be easily assembled into a sturdy lampshade, without tools or any fastening means at all.

U.S. Pat. No. 5,115,385 (Jeckle) discloses a lamp, combining both a shade and a self-supporting base. The shade and self-supporting base are configured to conform to a wall surface in such a way that the amount of space occupied is minimized. Indeed, the shaped surfaces of the lamp shade and/or the supporting base may be selected to conform substantially to a flat wall surface, and also to both the inside and outside corners of a wall surface. Such configurations are achieved by making adjustment to both the slide members and the horizontal shade wire members.

However, it is worth mentioning that it is not disclosed or suggested in either U.S. Pat. Nos. 4,268,896 and 5,115,385, that the lamp be wall mounted or flush or resting against a wall surface in either a free-standing or wall mounted position.

Also known to the Applicant are the following U.S. patents which describe different lamps and various supporting means used therewith: U.S. Pat. Nos. 2,008,177 (Godfrey); 2,640,913 (Little); 2,680,920 (Harris); 2,841,697 (Smith); 3,116,027 (Kleppin); 3,601,600 (Cannon) 5,251,118 (Budnovitch) and 5,309,338 (Liu).

A significant problem associated with some of the above mentioned lighting devices is that they often use a means of locking and/or movable supporting members in order to position a lamp in either a wall mounted or a free-standing position.

As mentioned in U.S. Pat. No. 5,115,385, another problem associated with some of the lighting devices of the above-mentioned prior art lamps is that they become obtrusive when positioned adjacent to a wall surface. In such cases, the projecting shade, centered on the axis of the base, necessitates that the lamp be spaced from the wall by a distance substantially equal to or slightly greater than the radius of the shade. This creates difficulties, especially within confined areas where maximum space utilization is both needed and wanted.

The prior art, from this review, is seen to show the concept of interchangeable lamp units. As aforementioned, these units maybe either wall-mounted or table-mounted.

It is thus desirable to obtain specific lamp configurations, for example wall mounted, whereby both the lamp shade and the support frame will fit closely adjacent to a wall structure in such a way that the support frame is flush or resting onto a wall structure. This would provide maximum space utilization, and also provides for both an aesthetic and functional wall or table mounted lamp.

Hence, there is still presently a need for an improved interchangeable lamp that may be either wall-mounted or table-mounted.

### SUMMARY OF THE INVENTION

An object of the present invention is to provide a lamp that will satisfy the above-mentioned need.

In accordance with the invention, this object is achieved with a decorating lamp unit comprising:

a support frame having:

a front surface, a back surface, a top and a bottom, each of the front and back surfaces having two opposite side edges; the

bottom comprising a first and second contact point;

a first shade mountable onto the opposite side edges of the front surface, the first shade having a third contact point; and

a light bulb assembly connected to the support frame, the light bulb assembly being positioned between the front surface and the first shade.

As mentioned above, the lamp according to the invention has the advantage of being either wall mountable by fixing the support frame to a wall, or it is free-standing when placed on a surface with three contact points contacting a surface.

According to another aspect of the invention, there is also provided a kit for a lamp which is wall-mountable or settable on a planar surface comprising:

a support frame having:

a front surface, a back surface, a top and a bottom, each of the front and back surfaces having two opposite side edges;

the bottom comprising a first and second contact point;

a first shade mountable onto the opposite side edges of the front surface, the first shade having a contact point; and

a light bulb assembly connected to the support frame, the light bulb assembly being positioned between the front surface and the first shade.

As aforesaid, the decorating lamp unit according to the invention is particularly convenient for providing maximum space utilization and for colourfully illuminating a designated area. Such may be useful to create a warm environment for young children by illuminating effects.

Moreover, the invention also provides for a decorating lamp which uses a minimum amount of components, and which can easily be assembled by a user without any tools. This convenience allows for a short assembly time. Furthermore, the simple design of the lamp provides for a low manufacturing cost, and inevitably a low purchase cost.

The invention and its advantages will be better understood upon reading the following non-restrictive description of a preferred embodiment thereof, made with reference to the accompanying drawings.

### BRIEF DESCRIPTION OF THE DRAWINGS

FIG. 1 is an exploded perspective view of a decorating lamp unit according to a preferred embodiment of the present invention.

FIG. 2 is a front view of the decorative lamp of FIG. 1.

FIG. 3 is a cross-sectional view of the lamp of FIG. 2 taken along the line III-III.

FIG. 4 is a side view of the lamp of FIG. 1.

FIG. 5 is a cross-sectional view of the lamp of FIG. 4 taken along the line V-V.

FIG. 6 is a top view of the lamp of FIG. 1 showing the protective grid.

FIG. 7 is a cross-sectional view of the protective grid of FIG. 6 taken along line VII-VII.

FIG. 8 is a front perspective view of the frame of the lamp of FIG. 1.

FIG. 9 is a top view of the frame of FIG. 8.

FIG. 10 is a bottom view of the frame of FIG. 8.

FIG. 11 is a front view of the frame of FIG. 8.

FIG. 12 is a cross-sectional view of the frame of FIG. 11 taken along the line

FIG. 13 is a cross-sectional view of the frame of FIG. 11 taken along the line XIII-XIII.

FIG. 14 is a cross-sectional view of the frame of FIG. 11 taken along the line XIV-XIV.

FIG. 15 is a rear view of the frame of FIG. 8.

FIG. 16 is a cross-sectional view of the frame of FIG. 15 taken along the line XVI-XVI.

FIG. 17 is a front view of the frame with the light bulb assembly mounted thereon.

FIG. 18 is a top view of the frame of FIG. 17

FIG. 19 is a side view of the frame of FIG. 17.

### DETAILED DESCRIPTION OF A PREFERRED EMBODIMENT OF THE INVENTION

In the following description, the same numerical references refer to similar elements. The embodiment of the figures is preferred only.

Before the present invention is disclosed and described, it is to be understood that the terminology used herein is for the purpose of describing particular embodiments only and is not intended to be limiting. It must be noted that, as used in the specification and appended claims, the term “front” refers to the surface wherein the first shade is connected to, and also to which the light assembly is preferably found. The term “back” refers to the surface that may be in contact with a wall surface.

Similarly, expressions such as “interchangeable”, and “convertible”, as well as any equivalent expressions and/or compound words thereof, may be used interchangeably in the context of the present description. As used herein, the term “interchangeable” and “convertible” refers to both wall mounted and table mounted configurations.

As used herein, the terms “table-mounted” and “free-standing” refer to the positions in which the lamp unit is used as a table lamp.

As also used herein, the term “first shade” and “second shade” can be used interchangeably. Indeed, the “first shade” and “second shade” are preferably manufactured to be similar, if not identical.

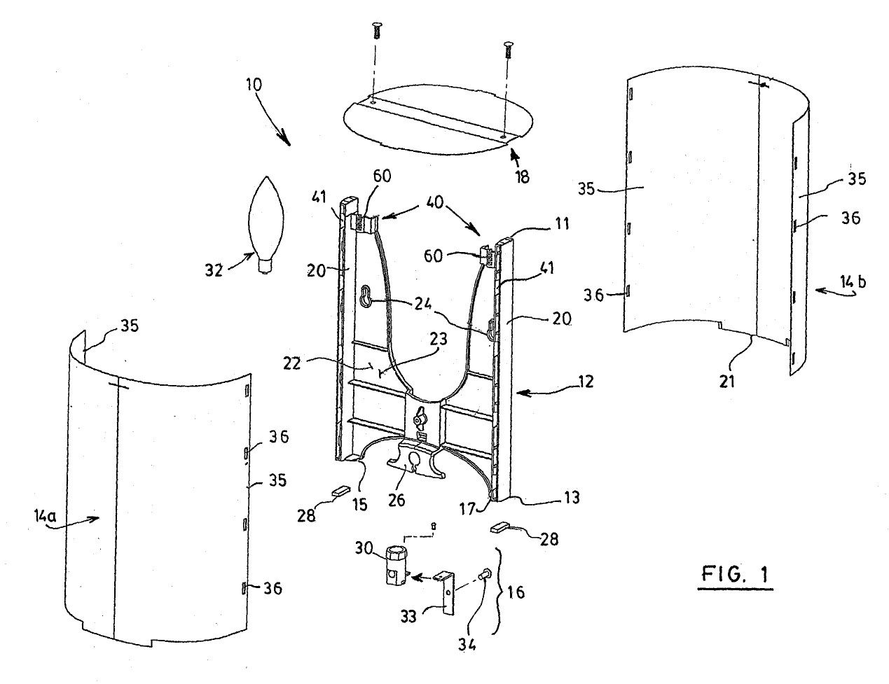

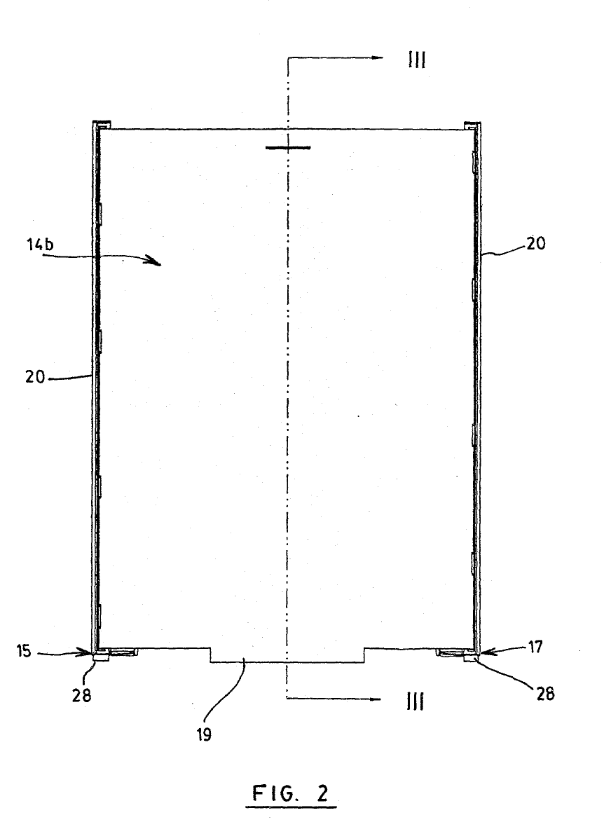

Referring to FIG. 1, the decorating lamp unit (10) comprises a support frame (12), a first shade (14a) and a light bulb assembly (16). The support frame (12) comprises a front surface (22), a back surface (23), a top (11) and a bottom (13), wherein each of the front (22) and back (23) surfaces has two opposite side edges (20). The bottom (13) also has a first (15) and second (17) contact point.

The first shade (14a) which is mountable onto the opposite side edges (20) of the front surface (22), preferably has a third contact point (19) that is used, in combination with the first (15) and second (17) contact points, to make the lamp free-standing. The first (15), second (17) and third (19) contact points are preferably downward extensions of the bottom (13) and shade (14a) respectively.

The first shade (14a) is preferably removably mountable to the support frame (12) so that the shade (14a) imprinted with a design can be replaced by another shade with a different design, and render the lamp (10) aesthetically appealing.

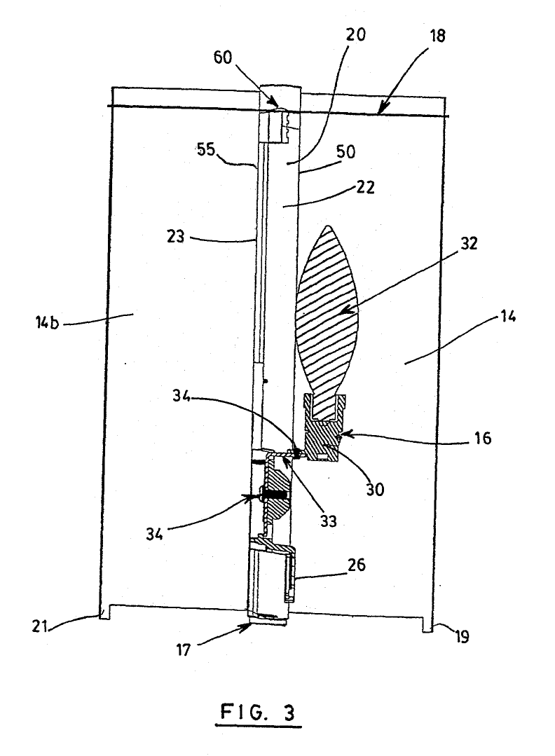

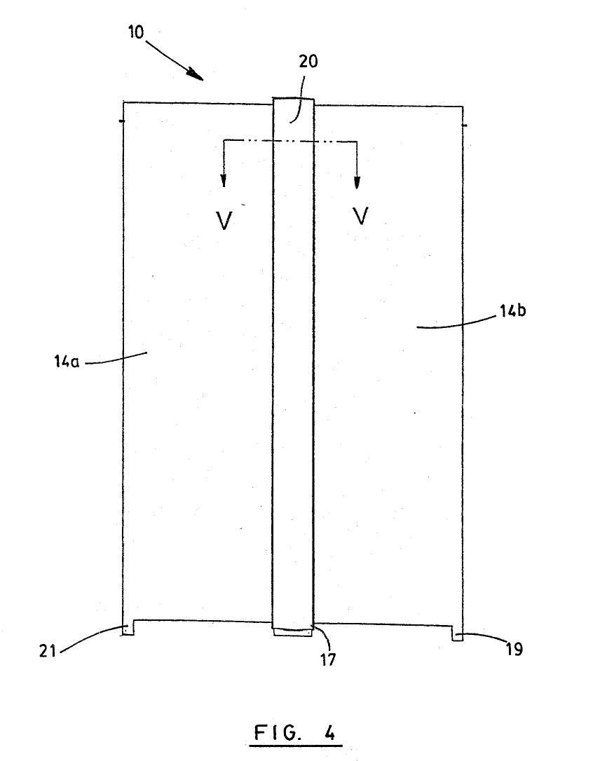

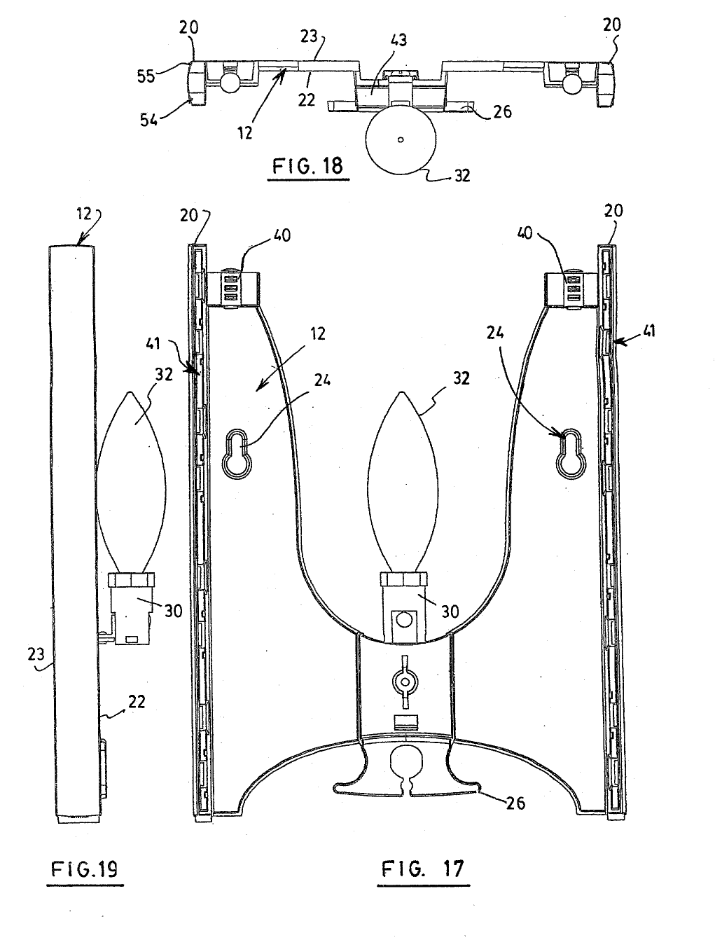

As a source of illumination, the lamp unit (10) comprises a light bulb assembly (16) as better shown in FIGS. 1, 3 and 17 to 19, which is connected to the support frame (12). Preferably, the light bulb assembly (16) is positioned between the front surface (22) and the first shade (14a). The light bulb assembly also comprises a socket (30) for receiving a light bulb (32) and fixing means for fixing the light bulb socket (30) to the frame (12) of the lamp (10). In this preferred embodiment, the fixing means comprises a bracket (33) mountable to location (43) on the frame (12), and screws (34). It is however worth noting that any other fixing means, such as a bolt, a glue, etc, known in the art could be used. The light bulb assembly (16) may also comprise a cord wind-up device (26) to prevent excess cord from dangling on the wall or floor. Preferably, the cord wind-up device (26) is integrated to the frame (12), but may be a separate component thereof.

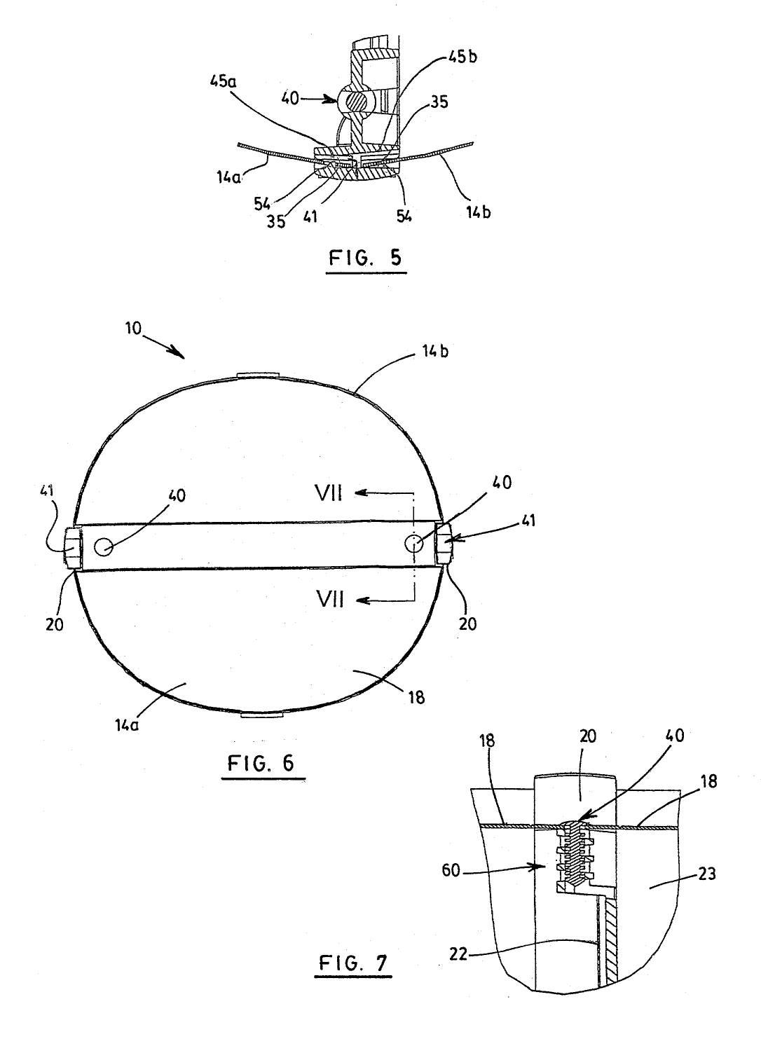

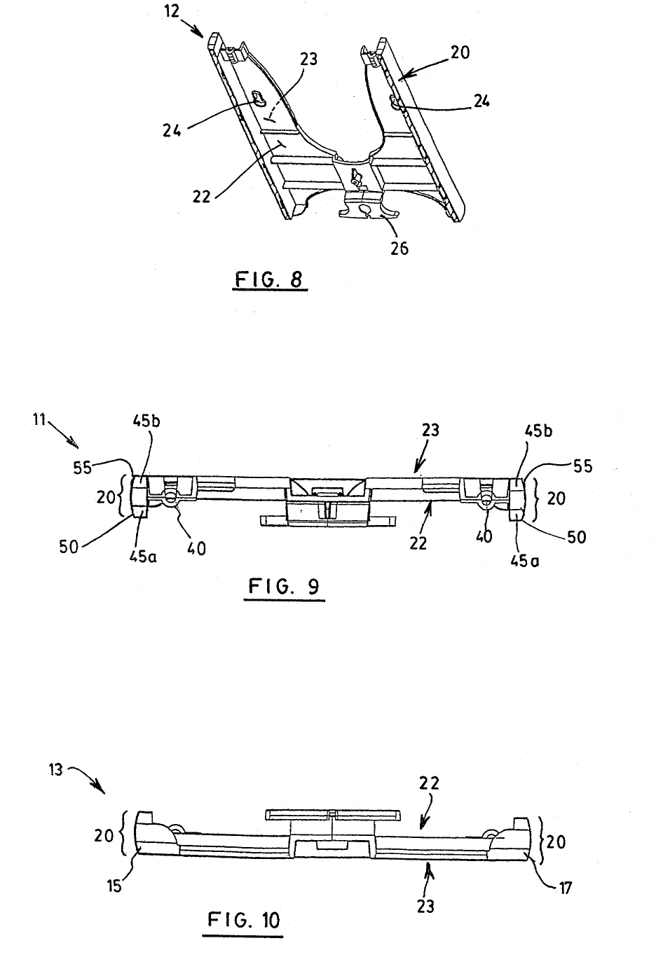

As better seen in FIGS. 6 to 8, the frame (12) further preferably comprises fixing means (40) positioned on top of the frame (12) to fix a protective grid (18) or a cover. As such, the decorating lamp unit (10) can also be provided with a protective grid (18) disposed or fixed on top (11) of the lamp (10) to prevent fingers, such as those of a child, from getting close to the light bulb.

Preferably, the fixing means (40) comprises insets (60) positioned on the top (11) of the lamp (10). The insets (60) are adapted to receive a fastener such as a screw, a bolt or any other fastening means that is known to a person skilled in the art. Preferably, the protective grid (18) is positioned slightly below the top of the first (14a) shade when the lamp (10) is to be wall or table mounted.

Even though it is not specifically shown in the Figures, the protective grid (18) may be shaped as a full circle or a semi-circle depending if the first (14a) and/or second shade (14b) is to be mountable or removably mountable onto the opposite side edges (20). For example, when the lamp (10) is used as a wall lamp and only the first shade (14a) is mounted to the support frame (12), a semi-circular protective grid (18) is to be used. When the lamp (10) is used as a table lamp, and both the first (14a) and second (14b) shades are mounted to the support frame (12), a full-circled protective grid (18) is to be used to prevent foreign objects from getting close to the light bulb.

Advantageously, the frame (12) may also be provided with rubber gripper feet (28) positioned on both the first (15) and second (17) contact points which are found on the bottom (13) of the support frame (12). The rubber gripper feet (28) help to prevent the lamp (10) from being moved around or knocked over when it is used as a desk- or table lamp. More preferably, the rubber gripper feet (28) are sized and shaped to fit the corresponding first (15) and second (17) contact points.

More preferably, and as mentioned above, the lamp unit (10) also comprises a second shade (14b) that is mountable onto the opposite side edges (20) of the back surface (23). In such a case, the second shade (14b) provides all around lighting, and it also provides a fourth contact point (21) which increases the stability of the lamp when it is free-standing.

The second shade (14b) is preferably removably mountable to the support frame (12) so that the shade imprinted with a design can be replaced by another shade with a different design.

As better shown in FIGS. 1 and 9, the lamp (10) is wall mountable by fixing the support frame (12) to a wall structure. Such is achieved by making use of the wall mounting means (24) integrated onto the support frame (12). More advantageously, the lamp (10) is wall mountable by fixing the back surface (23) of the support frame (12) against a wall structure in such a way that the back surface (23) rests against the wall structure. The wall mounting means may simply be, as shown, a screw-receiving hole.

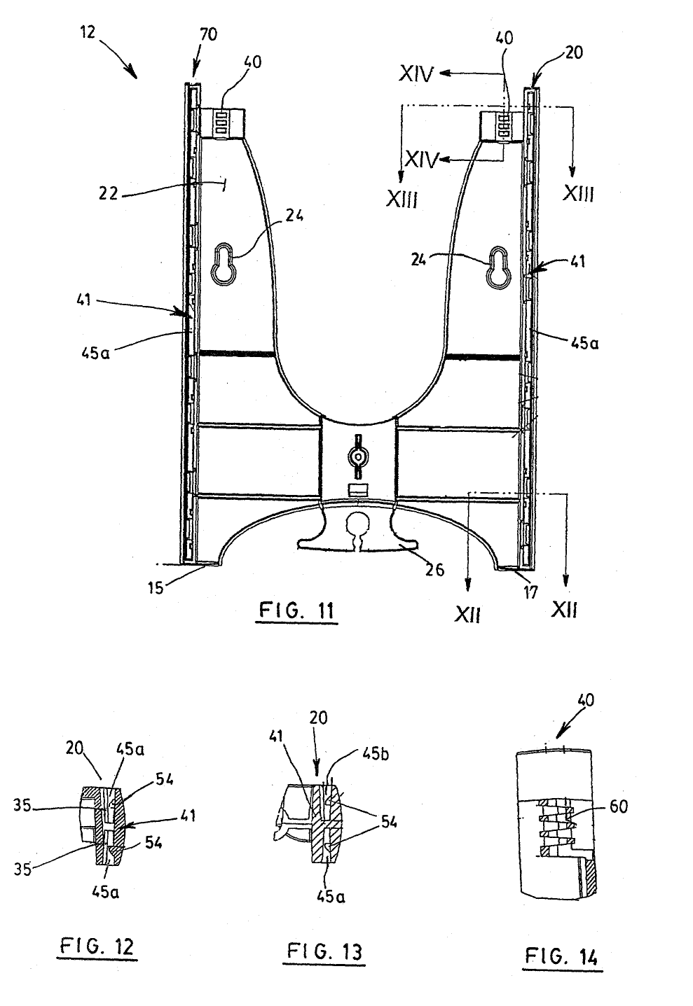

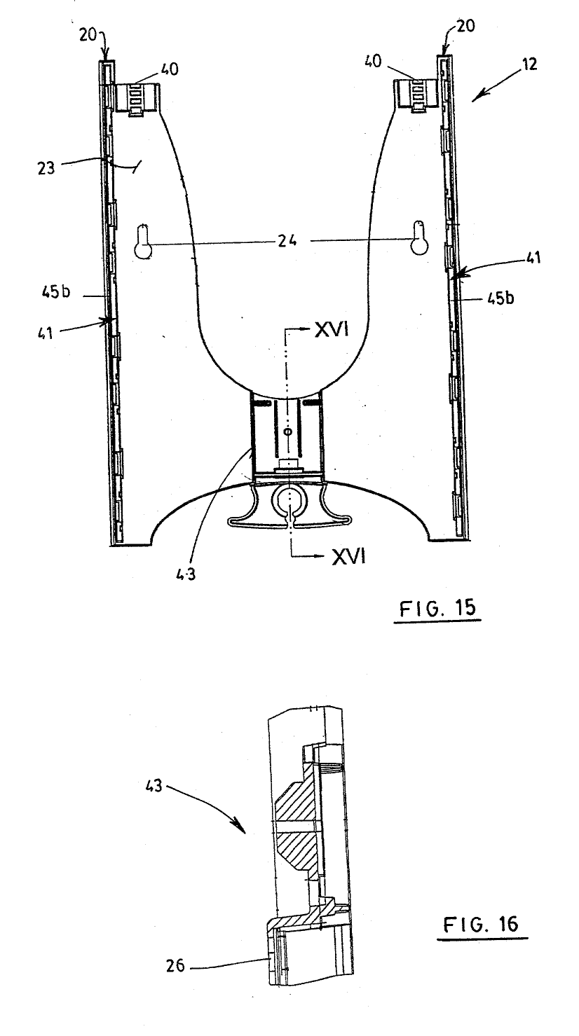

Now referring to FIGS. 5, and 11 to 13, the frame (12) comprises a mounting device (41) positioned on the opposite side edges (20) thereof to mount or removably mount the first (14a) and second (14b) shade to the frame (12).

More preferably, and as better seen in FIGS. 5, and 11 to 13, the mounting device (41), on each of the opposite side edges (20), comprises a front channel (45a) opposite a back channel (45b), both channels extending all along the side edge (20) of the frame (12). The front (45a) and the back (45b) channels are respectively for receiving a side edge (35) of the front and back shade (14a, 14b). The mounting device (41) further comprises holding means in each channel (45a, 45b) adapted to cooperate with the side edges (35) of the shades (14a, 14b) to hold the same in place. The holding means preferably comprises a series of protrusions (54) that are spaced and sized to squeeze the side edge (35) of the shade (14a, 14b) into the channel (45a, 45b). Preferably, this type of mounting device integrated onto the support frame (12) is devised in such a way to ensure a firm retention of the first (14a) and second (14b) shades by application of pressure created by the curving of the first (14a) and/or second (14b) shade. This concept is more specifically shown in FIG. 5.

It is however worth noting that in another embodiment, the series of protrusions may be spaced and sized to co-operate with corresponding slits (36) positioned along the side edges (35) of the first (14a) and second (14b) shades as shown in FIG. 1. As well, in a further embodiment, not illustrated, the mounting device may be a snap-button system or any other system known to a person skilled in the art.

Now referring more specifically to FIG. 9, the opposite side edges (20) of the frame (12) comprise a first part (50) embodying the front channel (45a) and a second part (55) embodying the back channel (45b). Preferably, the first part (50) extends outwardly with respect to the front surface (22) of the frame whereas the second part (55) is flushed with the back surface (23).This feature allows the back surface (23) to completely rest against the wall structure when the lamp is wall mounted.

The first (14a) and second (14b) shade are preferably made of a semi-rigid and translucent material, such as plastic material. It will be understood that the present invention also contemplates employing shades of other suitable materials. It is also worth mentioning that many types of designs can be imprinted onto the material for aesthetic consideration.

In sum, the decorative lamp (10) of the present invention can be used as a wall lamp or table lamp. The first (14a) and second (14b) shade makes the lamp (10) convertible from a wall lamp to a table lamp in minutes, without any tools.

Although a preferred embodiment of the present invention has been described in detail herein and illustrated in the accompanying drawings, it is to be understood that the invention is not limited to this precise embodiment and that various changes and modifications may be effected therein without departing from the scope or spirit of the present invention.

1. A decorating lamp unit comprising:
a support frame having:
a front surface, a back surface, a top and a bottom, each of said front and back surfaces having two opposite side edges;
said bottom comprising a first and second contact point;
a first shade mountable onto said opposite side edges of said front surface, said first shade having a third contact point;
a light bulb assembly connected to the support frame, said light bulb assembly being positioned between the front surface and the first shade;
wherein said lamp is wall mountable by fixing said support frame to a wall, or said lamp is free-standing when placed on a surface with said first, second and third contact points contacting said surface.

2. A lamp unit according to claim 1, further comprising a second shade mountable onto said opposite edges of said back surface.

3. A lamp unit according to claim 2, wherein the second shade has a fourth contact point.

4. A lamp unit according to claim 1, comprising a wall mounting means integrated onto said support frame to mount said frame onto a wall structure.

5. A lamp unit according to claim 2, wherein the first and second shades are mountable to the frame by means of a mounting device.

6. A lamp unit according to claim 5, wherein the mounting device is a tongue and groove system.

7. A lamp unit according to claim 1, further comprising fixing means positioned on top of said frame for fixing a protective grid.

8. A lamp according to claim 1, further comprising a cord-wind up device to prevent excess cord from dangling.

9. A lamp unit according to claim 1, further comprising rubber gripper feet on said first and second contact points.

10. A lamp unit according to claim 1, wherein the back surface rests against the wall structure when the lamp is wall mounted.

11. A lamp unit according to claim 2, wherein the first and second shade are made of a semi-rigid and translucent material.

12. A kit for a lamp which is wall-mountable or settable on a planar surface comprising:
a support frame having:
a front surface, a back surface, a top and a bottom, each of said front and back surfaces having two opposite side edges;
said bottom comprising a first and second contact point;
a first shade mountable onto said opposite side edges of said front surface, said first shade having a contact point; and
a light bulb assembly connected to the support frame, said light bulb assembly being positioned between the front surface and the first shade.

13. A kit according to claim 12, further comprising a second shade mountable onto said opposite edges of said back surface.

14. A kit according to claim 12, further comprising fixing means positioned on top of said frame to fix a protective grid.

15. A kit according to claim 12, further comprising rubber gripper feet on said first and second contact points.
